(19) United States
(12) Patent Application Publication
(10) Pub. No.: US 2023/0332773 A1
(43) Pub. Date: Oct. 19, 2023

(54) COOKING SYSTEM

(71) Applicant: BSH Hausgeräte GmbH, Munich (DE)

(72) Inventors: Beatriz Arenas Jimenez, La Muela (ES); Noelia Borque Marquina, Zaragoza (ES); Jose Maria Garcia del Pozo, Zaragoza (ES); Diana Lascorz Pascual, Zaragoza (ES); Javier Lasobras Bernad, EJEA DE LOS CABALLEROS (ZARAGOZA) (ES); Damaso Martin Gomez, Zaragoza (ES); Pilar Perez Cabeza, Zaragoza (ES); Julio Rivera Peman, Cuarte de Huerva (Zaragoza) (ES); Fernando Sanz Serrano, Calamocha (Teruel) (ES); Francisco Villuendas Lopez, Zaragoza (ES)

(21) Appl. No.: 18/022,785

(22) PCT Filed: Sep. 9, 2021
(86) PCT No.: PCT/EP2021/074756

§ 371 Date: Feb. 23, 2023

(30) Foreign Application Priority Data
Sep. 18, 2020 (EP) 20382824

(51) Int. Cl. F24C 15/10; H05B 6/06; F24C 7/08

(52) U.S. Cl. CPC F24C 15/102; H05B 6/062; F24C 7/083; H05B 2213/07

(57) ABSTRACT

A cooking system includes a placement plate, and a radiation guiding element which is permeable for infrared radiation and visible light. The radiation guiding element extends in an assembled state at least in part along a normal direction perpendicular to a main extent plane of the placement plate from an upper side to a lower side of the placement plate.

The invention relates to a cooking system as claimed in claim 1 and a method for operating a cooking system as claimed in claim 19.

Cooktops having sensors for ascertaining a temperature of cookware that is placed on a cooktop plate are already known from the prior art. In the case of some known cooktops, the sensors in this case are arranged below the cooktop plate and are designed as NTC temperature sensors. A disadvantage in this case is that, due to a relatively large distance between the sensor and the cookware, a temperature measurement is only very inaccurate and/or owing to the low thermal conductivity of the cooktop can only take place after a long delay with the result that operating convenience and operational safety for a user are greatly limited. In some known cooktops, the cooktop plate is therefore made of a material that has a high thermal conductivity in order to increase the measurement accuracy but this in turn is associated with disadvantages with respect to increased costs and/or reduced flexibility when selecting a material for the cooktop plate and it can also reduce user satisfaction. Other known cooktops therefore have temperature sensors which are integrated directly in the cooktop plate. By way of example, the publication EP 0 579 067 B1 discloses a cooktop plate having integrated hemispherical elements in which temperature sensors are arranged. However, this has a disadvantage that the hemispherical elements protrude above the surface of the cooktop plate and consequently cause unevenness in the surface of the cooktop plate, which reduces the stability of cookware placed thereon and consequently considerably reduces operating convenience for a user.

The object of the invention is in particular but not limited thereto to advantageously further develop generic systems and methods. The object is achieved in accordance with the invention by the features of claim 1 and claim 19, while advantageous embodiments and developments of the invention are apparent in the subordinate claims.

A cooking system, in particular an induction cooking system, having a placement plate and a radiation guiding element is proposed which is permeable for infrared radiation and visible light and which in an assembled state extends at least in part along a normal direction, which is perpendicular to a main extent plane of the placement plate, from an upper side to a lower side of the placement plate.

An embodiment of this type renders it advantageously possible to improve operating convenience for a user. Since the radiation guiding element extends from the upper side to the lower side of the placement plate, a particularly fast, reliable and accurate measurement of a temperature of an item of cookware that is arranged on the upper side of the placement plate can be advantageously achieved by means of a temperature sensor that is arranged below the radiation guiding element. This can also advantageously increase the operational safety for a user, in that, by way of example, if an item of cookware is forgotten on the placement plate in the case of a heating element that is switched on, it is possible to quickly detect an excessive temperature and issue a warning to a user. In addition, it is advantageously possible to use placement plates made of a wide variety of materials, in particular also materials with low thermal conductivity, whereby the placement plate can be advantageously adapted to the individual needs of a user. Furthermore, there is the advantageous possibility of illuminating partial areas of the upper side of the placement plate by way of an illumination unit that is arranged on the lower side of the placement plate by means of the radiation guiding element, in order to further improve operating convenience for a user. In addition, a particularly simple assembling of the placement plate can be rendered possible if no sensors are integrated in the placement plate. Furthermore, partial areas of the upper side of the placement plate can be made impermeable or translucent outside of the radiation guiding element, whereby a particularly esthetic cooking system can be provided and a user satisfaction can be further increased.

A cooking system is to be understood as a system which has at least the placement plate and at least the radiation guiding element and which could have in particular in addition at least one further unit. The cooking system can be designed at least as one part, in particular as a subassembly, of a cooktop, in particular of an induction cooktop, wherein the cooking system can also comprise in particular additionally accessories for the cooktop, by way of example a sensor unit for external measurement of a temperature of an item of cookware and/or of food to be cooked. By way of example, the cooking system could have at least one cooktop object which could be in particular a subassembly of a cooktop. The cooktop object could have by way of example at least one control unit and/or at least one operator interface and/or at least one housing unit and/or at least one heating unit and/or at least one extractor fan unit and/or at least one set of heating unit control electronics.

A placement plate is to be understood in particular as at least one in particular plate-like unit which in at least one operating state is provided for placing thereon at least one item of cookware and/or for placing thereon at least of one item of food to be cooked for heating purposes. The placement plate could be designed by way of example as a worktop or as an area of at least one worktop, in particular at least one kitchen worktop, in particular of the cooking system. As an alternative or in addition, the placement plate could also be designed as a cooktop plate. The placement plate that is designed as a cooktop plate could in particular form at least one part of a cooktop outer housing and in particular, together with at least one outer housing unit to which the placement plate that is designed as a cooktop plate could be connected in at least an assembled state, form the cooktop outer housing at least to a large extent. The placement plate could by way of example be made at least to a large extent of glass and/or of glass ceramics and/or of neolith and/or of dekton and/or wood and/or of marble and/or of stone, in particular of natural stone, and/or of laminate and/or of metal and/or of plastic and/or of ceramics.

A radiation guiding element is to be understood as an element which is permeable both for infrared radiation, in particular infrared radiation having a wave length range between 800 nm and 7,000 nm, and also for visible light having a wave length range between 380 nm and 800 nm and which is provided so as to transport visible light and/or infrared radiation at least in part along the normal direction of the placement plate from the upper side to the lower side of the placement plate and/or from the lower side to the upper side of the placement plate. It is preferred that the radiation guiding element is at least substantially in the shape of a cylinder, having an oval, preferably circular, cross-section perpendicular to the normal direction. Alternatively, the radiation guiding element could have a shape different to that of a cylinder and have a polygonal, by way of example rectangular or triangular, cross-section in a perpendicular manner with respect to the normal direction. It is preferred that the radiation guiding element is at least to a large extent, in particular preferably completely, made of quartz. The radiation guiding element can alternatively also be made at least to a large extent, preferably completely, of sapphire. The term “at least to a large extent” is to be understood as a material quantity fraction of at least 55%, advantageously at least 65%, preferably at least 75%, particularly preferably at least 85% and especially advantageously at least 95%. The cooking system can have a plurality of radiation guiding elements which in the assembled state can be arranged offset with respect to one another with regard to the main extent plane of the placement plate.

A main extent plane of a component is to be understood as a plane which is parallel to a largest side surface of a smallest imaginary cuboid which just completely encloses the component, and in particular passes through the center of the cuboid. A normal direction of an object is to be understood to be a direction which is perpendicular to the main extent plane of the object.

Provided is to be understood to be especially designed and/or equipped. The fact that an object is provided to perform a specific function is to be understood in particular that the object fulfills and/or executes this specific function in at least one application state and/or operating state.

It is further proposed that at least one partial area of the placement plate outside the radiation guiding element has a lower transmittance at least for visible light than the radiation guiding element. This can advantageously render possible a particularly precise transport of the infrared radiation and/or the visible light with particularly low scattering losses. In addition, the esthetics of the placement plate can be advantageously improved. In the at least one partial area outside the radiation guiding element, the placement plate could, by way of example, have an impermeable coating that is applied to the upper side. In addition, it is conceivable that the placement plate is made of a material having a lower transmittance than the radiation guiding element. In the at least one partial area outside the radiation guiding element, the placement plate could, by way of example, have a translucent material, in particular it could be made of a translucent material over an entire extent of the partial area in the normal direction. The partial area of the placement plate outside the radiation guiding element can extend over the entire main extent plane of the placement plate.

The radiation guiding element could be formed integrally with the placement plate, wherein a transmittance in the partial area of the placement plate outside the radiation guiding element could be subsequently reduced by a suitable process, by way of example by the impermeable coating of the upper side. In an advantageous embodiment, however, it is proposed that the radiation guiding element is integrated in the assembled state in a cut-out of the placement plate. Advantageously, this can improve a manufacturing process of the cooking system and/or increase flexibility in manufacturing. If the radiation guiding element is integrated in the assembled state in a cut-out of the placement plate, the placement plate can advantageously be made of materials which differ from a material of the radiation guiding element and which, by way of example, can be more cost-effective and/or easier to assemble and/or can be adapted to individual requirements of a user. Integrally is to be understood as at least materially joined, by way of example by a welding process, an adhesive process, an injection molding process and/or any other process which appears expedient to the skilled person, and/or advantageously formed in one piece, such as by being manufactured from a casting and/or by being manufactured in a single-component or multi-component injection molding process and advantageously from a single blank. The cut-out of the placement plate preferably extends at least in part along the normal direction from the upper side to the lower side of the placement plate and can be introduced into the worktop by a suitable forming process either directly during the manufacture of the placement plate, by way of example by a suitable casting mold, or subsequently, by way of example by a drilling process or a milling process or the like. It is preferred that a geometric shape, in particular an inner diameter, of the cut-out corresponds at least substantially to a geometric shape, in particular an outer diameter, of the radiation guiding element, in particular taking into account tolerances that are required for mounting the radiation guiding element in the cut-out. In the assembled state, the radiation guiding element can be integrated in the cut-out in a positive-locking manner and/or a non-positive locking manner. As an alternative or in addition, it is conceivable that the radiation guiding element is integrated in the assembled state in the cut-out in a material-locking manner, by way of example by an adhesive process. It is preferred that the radiation guiding element is integrated in the assembled state in the cut-out of the placement plate in such a way that it forms a flush transition with the upper side of the placement plate perpendicular to the normal direction.

In addition, it is proposed that the radiation guiding element has a significantly smaller surface area than the placement plate when viewed along the normal direction. This renders it possible to achieve a particularly efficient use of materials for the radiation guiding element and thus save costs. In addition, the esthetics of the cooking system and thus user satisfaction can be advantageously improved. It is preferred that the surface area of the radiation guiding element corresponds to at most 1%, particularly preferably at most 0.5%, of the surface area of the placement plate when viewed along the normal direction.

Furthermore, it is proposed that the cooking system has a further radiation guiding element which is permeable for infrared radiation and visible light and which in the assembled state is arranged offset along the normal direction with respect to the radiation guiding element and interacts optically therewith. A design of this type can advantageously improve the transport of infrared radiation and/or visible light, in particular from and/or to further units, by way of example a sensor unit and/or an illumination unit. In addition, an assembling of the placement plate can advantageously be improved. It is preferred that the further radiation guiding element is designed substantially identically to the radiation guiding element, in particular with respect to a permeability of infrared radiation and visible light, wherein in particular a main extent of the radiation guiding element in the normal direction of the placement plate can differ from a main extent of the further radiation guiding element in the normal direction of the placement plate. It is preferred that the further radiation guiding element directly adjoins the radiation guiding element in the mounted state in the normal direction of the placement plate in order to improve an optical interaction, in other words a transmission of the infrared radiation and/or the visible light between the radiation guiding element and the further radiation guiding element. However, it is also conceivable, in particular for manufacturing or assembling reasons, that in the assembled state there is a gap in the normal direction between the radiation guiding element and the further radiation guiding element.

In the assembled state, the radiation guiding element can have an extent along the normal direction which at least substantially corresponds to an extent of the placement plate along the normal direction. In an advantageous embodiment, however, it is proposed that the radiation guiding element in the assembled state has a greater extent along the normal direction than the placement plate. An arrangement of this type can advantageously render possible a particularly low-loss transmission of infrared radiation and/or visible light to and/or from a further unit, in particular a sensor unit and/or an illumination unit. It is preferred that the radiation guiding element extends in the assembled state along the normal direction over the lower side of the placement plate and forms perpendicular to the normal direction a flush transition with the upper side of the placement plate.

It is further proposed that the cooking system has a sensor unit for detecting at least one sensor parameter and which in the assembled state is arranged offset along the normal direction with respect to the radiation guiding element. This advantageously renders possible a particularly fast and precise detection of sensor parameters by interaction of the sensor unit with the radiation guiding element and simultaneously improves a manufacturing process and/or assembling process, since the sensor unit is not integrated in the placement plate. In this context, a sensor unit is to be understood as a unit which is provided so as to ascertain at least one parameter and/or one physical characteristic, wherein said parameter and/or physical characteristic can be ascertained actively, such as in particular by generating and transmitting an optical and/or electrical measurement signal, and/or passively, such as in particular by detecting changes in the characteristics of a sensor component. Various sensor units are conceivable which appear expedient to the person skilled in the art.

It is also proposed that the sensor unit has at least one infrared temperature sensor. A design of this type can advantageously render possible a particularly precise temperature measurement, in particular of an item of cookware that is placed on the placement plate. The infrared temperature sensor could without being limited thereto be designed, by way of example, as a photoelectric sensor, in particular as a photodiode, or as a pyroelectric infrared sensor.

Furthermore, it is proposed that the sensor unit has at least one sensor element which is provided so as to assist the infrared temperature sensor and/or to detect a further sensor parameter. An embodiment of this type renders it advantageously possible to further improve an accuracy of a temperature measurement by means of the infrared temperature sensor. In addition, a measurement of at least one further sensor parameter can advantageously be made possible. The sensor element could be designed as a further temperature sensor, in particular as an NTC temperature sensor, which is provided so as to assist the infrared temperature sensor for the purpose of measuring an ambient temperature of the infrared temperature sensor in order thereby to render it possible to take into consideration an influence of the ambient temperature in the case of the temperature measurement by means of the infrared temperature sensor and to render possible a particularly accurate and less error-prone temperature measurement. As an alternative or in addition, it is conceivable that the sensor element has an infrared radiation source or is designed as the infrared radiation source. The infrared radiation source could be provided so as to emit a reference infrared signal so as to detect an emissivity of a medium, by way of example a material of an item of cookware or air, located on the upper side of the placement plate when viewed along the normal direction, in relation to an ideal heat emitter with an emissivity of 1. This can advantageously render it possible to calibrate the infrared temperature sensor and thus to further improve an accuracy of the temperature measurement. It is also conceivable that the sensor element is provided so as to detect the presence of an item of cookware as a further sensor parameter. A detection of a presence of an item of cookware could, by way of example, also be carried out with the aid of the infrared radiation source, in that an increase in an emissivity of the medium which is located in the normal direction on the upper side of the placement plate and which is almost zero for air can be detected by the infrared temperature sensor. As an alternative or in addition, it would be conceivable that a detection of cookware is performed by a sensor element that is different from an infrared radiation source and is suitable for the detection, by way of example by means of an optical sensor element, such as a camera or the like.

Furthermore, it is proposed that the cooking system has an illumination unit which in the assembled state is arranged offset along the normal direction with respect to the radiation guiding element, and said illumination unit couples visible light into the radiation guiding element in an operating state. An embodiment of this type can advantageously further improve the operating convenience and/or an operating experience for a user. An illumination unit is to be understood as a unit which has at least one light source and which provides light, in particular visible light, in at least one operating state, in particular by means of the light source. At least one light source of the illumination unit could, by way of example, be designed as a, preferably backlit, display unit, in particular as a matrix display unit, preferably as an LCD display, or as an OLED display. Advantageously, at least one light source of the illumination unit, particularly advantageously at least a majority of the light sources, preferably all light sources of the illumination unit, are designed as LEDs, in particular as RGB LEDs. The visible light that is provided by the at least one light source of the illumination unit in the operating state and is coupled into the radiation guiding element can be transported by means of the radiation guiding element from the lower side to the upper side of the placement plate and thus advantageously render it possible to illuminate at least one close-up region of the radiation guiding element on the upper side of the placement plate. The illumination of the at least one close-up region of the radiation guiding element on the upper side of the placement plate renders functional advantages possible, in addition to improved esthetics of the cooking system for a user. By way of example, it is conceivable that an operating state of the cooking system can be displayed by means of the illumination unit on the upper side of the placement plate. Furthermore, it is conceivable that a temperature of the surface of the placement plate can be displayed, by way of example by means of different colors of a visible light that is provided by at least one light source of the illumination unit that is configured as an RGB LED, in order to thus further improve user convenience and/or an operating experience for a user.

It is further proposed that the cooking system comprises a heating element, in particular an induction heating element, which at least in part surrounds the radiation guiding element when viewed along the normal direction. This can advantageously simplify assembling. It is preferred that in the assembled state the radiation conducting element extends in a central region of the heating element when viewed along the normal direction. It is preferred that the heating element in the central region, in particular a coil carrier of the heating element, forms a holding structure for further units of the cooking system, in particular for the sensor unit and/or the illumination unit.

In a further aspect of the invention, which can be considered on its own but also in combination with the other aspects of the invention, a cooking system is proposed having a placement plate and a thermal insulation element which can be arranged on the upper side of the placement plate and is provided so as to protect the placement plate against temperature influences and which has a cut-out through which the placement plate is visible. An arrangement of this type renders it advantageously possible to protect the placement plate against temperature influences. By means of the thermal insulation element, the placement plate can be advantageously protected against temperature influences which can be caused by an item of cookware that is placed on the placement plate and heated and which can cause an uneven thermal expansion of the worktop, which can lead to increased component stresses and thus to damage to the worktop. Furthermore, by the thermal insulation element having the cut-out through which the worktop is visible, it is advantageously possible to combine it with the other aspects of the invention, in particular with aspects relating to the radiation conducting element, and the advantages resulting therefrom. It is preferred that the thermal insulation element is provided for placing an item of cookware thereon. It is preferred that the thermal insulation element has at least one material with a very low thermal conductivity of at most 0.021 W/(m K), advantageously at most 0.020 W/(m K), particularly advantageously at most 0.019 W/(m K), preferably at most 0.018 W/(m K) and particularly preferably at most 0.017 W/(m K). The material with the very low thermal conductivity may be, by way of example, an aerogel. It is preferred that the thermal insulation element has a core which is completely enveloped by an outer shell. It is preferred that the core of the thermal insulation element is made of the material with the very low thermal conductivity, particularly advantageously an aerogel. It is preferred that the outer shell is made of a liquid-repellent and temperature-resistant material having a low thermal conductivity of at most 0.3 W/(m K), by way of example a plastic from the group of polysiloxanes. It is preferred that the thermal insulation element has a material thickness of at least 3 mm.

It is further proposed that a diameter of the cut-out corresponds at least to a diameter of the radiation guiding element. As a result, advantageously the previously mentioned advantages of the radiation guiding element and the thermal insulation element can be combined. It is preferred that a diameter of an object is to be understood as the diameter of a smallest circle that just encloses the object. It is preferred that the diameter of the cut-out is larger than the diameter of the radiation guiding element. This can advantageously facilitate a positioning of the cut-out of the thermal insulation element with regard to the radiation guiding element on the upper side of the placement plate for a user. It is preferred that the diameter of the cut-out of the thermal insulation element is at least 50%, advantageously at least 75%, particularly advantageously at least 100%, preferably at least 150% and particularly preferred at least 200% greater than the diameter of the radiation guiding element.

It is also proposed that the insulating element has an upper side and a lower side which has a lower degree of roughness than the upper side and which is provided for contacting the placement plate. A design of this type renders it possible to advantageously improve an operating convenience for a user. It can advantageously facilitate a displacement of the thermal insulation element together with an item of cookware that is placed thereon on the upper side of the placement plate. It is preferred that the upper side of the thermal insulation element is provided for placing an item of cookware thereon. It is preferred that the upper side has a high degree of roughness which is designed so as to counteract slippage of an item of cookware that is placed on the upper side of the thermal insulation element relative to the thermal insulation element. It is preferred that the lower side has a low degree of roughness, which is designed to promote displacement of the thermal insulation element together with an item of cookware that is placed thereon on the upper side of the placement plate. It is preferred that an average roughness value that characterizes the roughness of the lower side in accordance with the DIN 3141 standard is at least 0.4 μm, advantageously at least 0.8 μm, particularly advantageously at least 1.6 μm, preferably at least 3.2 μm and particularly preferably at least 6.3 μm lower than an average roughness value that characterizes the roughness of the upper side. Material depressions and/or material elevations, by way of example grooves and/or nubs and/or the like, could be introduced or applied to the upper side of the thermal insulation element, by way of example, in order to achieve a high degree of roughness. As an alternative or in addition, a slip-resistant coating could be applied to the upper side of the thermal insulation element. The lower side of the thermal insulation element can have a low degree of roughness due to the material. In addition, it is conceivable that a surface of the lower side of the thermal insulation element is treated, by way of example sealed, to further reduce roughness.

Furthermore, it is proposed that the cooking system has a position sensor unit which is provided so as to detect a positioning of the thermal insulation element. This can advantageously increase convenience and/or safety for a user. By way of example, it is advantageously possible to make a user aware of a lack of the thermal insulation element by means of the position sensor unit, which can further advantageously reduce a risk of damage to the placement plate due to temperature influences and/or reduce a risk of fire. It is preferred that the position sensor unit has at least one positioning sensor element. The positioning sensor element could be designed as an optical sensor and in an assembled state be arranged offset along the normal direction with respect to the radiation guiding element. It is preferred that the positioning sensor element is designed as a temperature sensor, in particular as an NTC temperature sensor. It is preferred that in the assembled state the positioning sensor element is arranged below the placement plate in a direction perpendicular to the normal direction of the radiation conducting element and is in contact with the lower side of the placement plate. It is preferred that the positioning sensor element is provided so as to measure a temperature of the placement plate at regular time intervals. The position sensor unit preferably detects the positioning of the thermal insulation element on the basis of a change in a temperature of the placement plate that is measured by the positioning sensor element. The position sensor unit is provided so as to detect at least two different positionings of the thermal insulation element, namely at least one presence and at least one absence of the thermal insulation element on the upper side of the placement plate. Furthermore, it is conceivable that the positioning sensor unit, in particular in combination with the infrared temperature sensor of the sensor unit, is provided so as to detect further positionings of the thermal insulation element, in particular with regard to an alignment of the cut-out of the thermal insulation element to the upper side of the placement plate. In the event that the thermal insulation element is positioned on the upper side of the placement plate in such a way that the radiation guiding element is completely or in part covered by the thermal insulation element, a temperature that can be measured by the infrared sensor would substantially correspond, in particular taking into account tolerances of at most 2° C., to a temperature which can be measured by the positioning sensor element. This makes it possible to detect incorrect positioning of the thermal insulation element with regard to the alignment of the cut-out. As an alternative or in addition, it is conceivable that the position sensor unit is provided so as to detect the positioning of the thermal insulation element by means of wireless signal transmission and, for this purpose, has at least one signal transmission element which is provided for unidirectional or bidirectional wireless data communication with a further signal transmission element which is integrated in the thermal insulation element. By way of example, it is conceivable that the signal transmission element is designed as an element for receiving radio signals, by way of example according to the Bluetooth standard and/or the RFID standard and/or another suitable radio standard, and the further signal transmission element is designed as a transmitter for transmitting the radio signals. Furthermore, it is proposed that the placement plate is designed as a cooktop plate. As a result, a cooking system having a cooktop plate having the aforementioned advantageous characteristics can be provided.

In an alternative embodiment, it is proposed that the placement plate is designed as a kitchen worktop. As a result, it is possible to provide a cooking system having a kitchen worktop having the aforementioned advantageous characteristics. It is preferred that the kitchen worktop forms a cooking area in at least one partial area, the position of which can be indicated to a user by means of the radiation guiding element and the illumination unit.

The invention further relates to a cooktop, in particular an induction cooktop, having a cooking system in one of the previously described embodiments. A cooktop of this type is characterized in particular by its advantageous characteristics in terms of improved operating convenience and/or operating experience for a user, as well as by simplified assembling.

A method is also proposed for operating a cooking system having a placement plate, wherein visible light is transported from a lower side to an upper side of the placement plate and infrared radiation is transported from the upper side to the lower side of the placement plate. A method of this type advantageously renders possible a particularly convenient operation of the cooking system. It is preferred that in the method visible light is transported from a lower side to an upper side of the placement plate and infrared radiation is simultaneously transported from the upper side to the lower side of the placement plate. However, it would also be conceivable that a transport of visible light takes place with a time delay with respect to a transport of infrared radiation. In addition, it is conceivable that in the method visible light is transported from the lower side to the upper side of the placement plate and infrared radiation is transported both from the upper side to the lower side of the placement plate and from the lower side to the upper side of the placement plate.

The cooking system as well as the method for operating the cooking system are not intended to be limited in this regard to the applications and embodiments described above. In particular, the cooking system can have a number of individual elements, components, and units different from a number of individual elements, components, and units described herein for the purpose of a fulfilling function described herein.

Further advantages are apparent in the following description of the drawings. Four exemplary embodiments of the invention are illustrated in the drawings. The drawings, the description and the claims have numerous features in combination. The person skilled in the art will also consider the features individually in a purposeful manner and combine them to form expedient further combinations.

In the drawings:

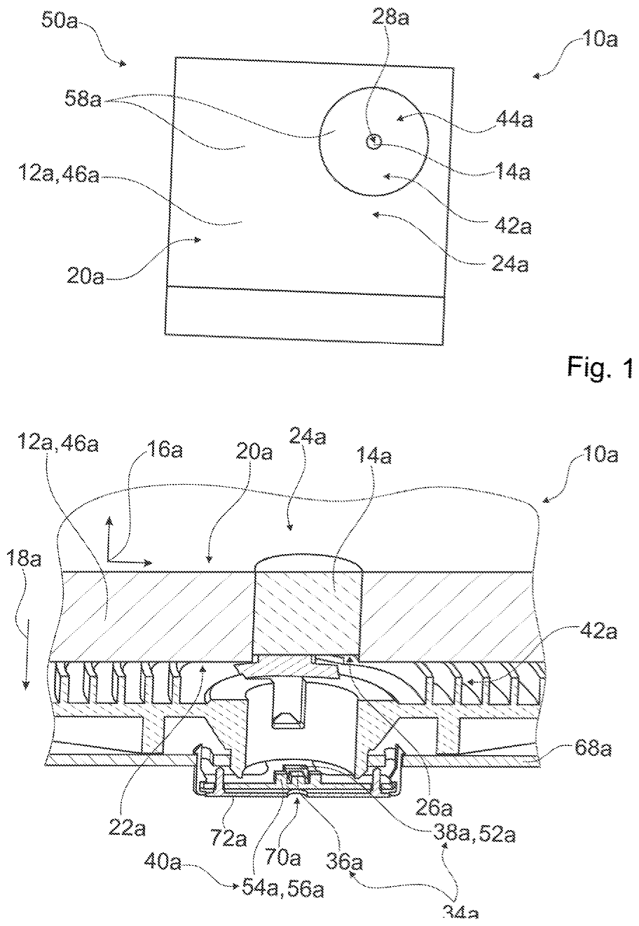

FIG. 1 shows a schematic plan view of a cooktop having a cooking system, comprising a placement plate that is designed as a cooktop plate and a radiation guiding element,

FIG. 2 shows a schematic sectional view of the cooking system shown in FIG. 1,

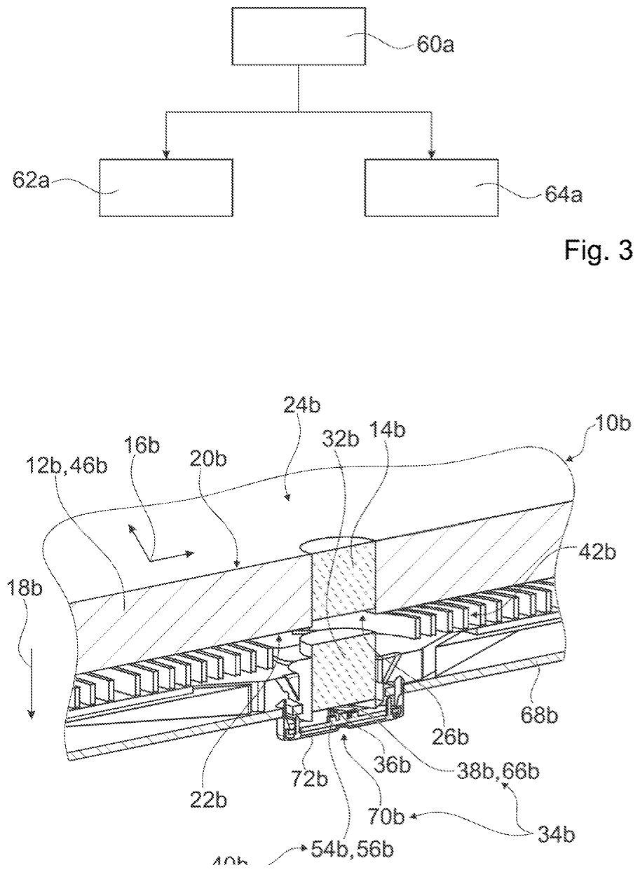

FIG. 3 shows a schematic method flow diagram of a method for operating a cooking system,

FIG. 4 shows a schematic sectional view of a further exemplary embodiment of a cooking system having a placement place, a radiation guiding element and a further radiation guiding element,

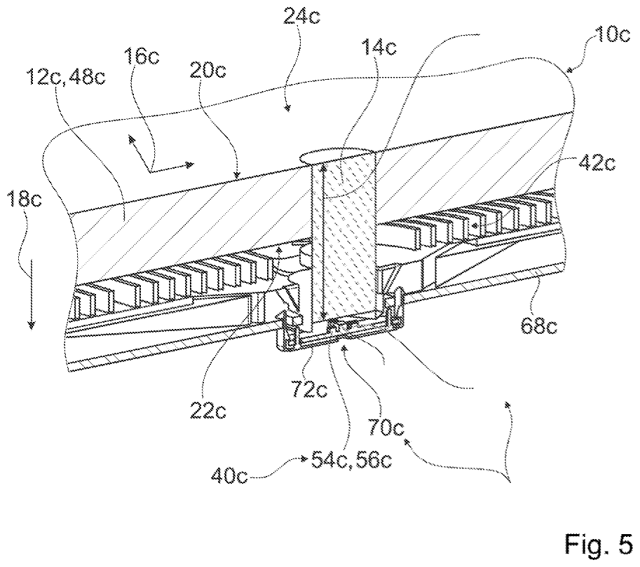

FIG. 5 shows a schematic sectional view of a further exemplary embodiment of a cooking system having a placement plate, which is designed as a kitchen worktop, and a radiation guiding element and

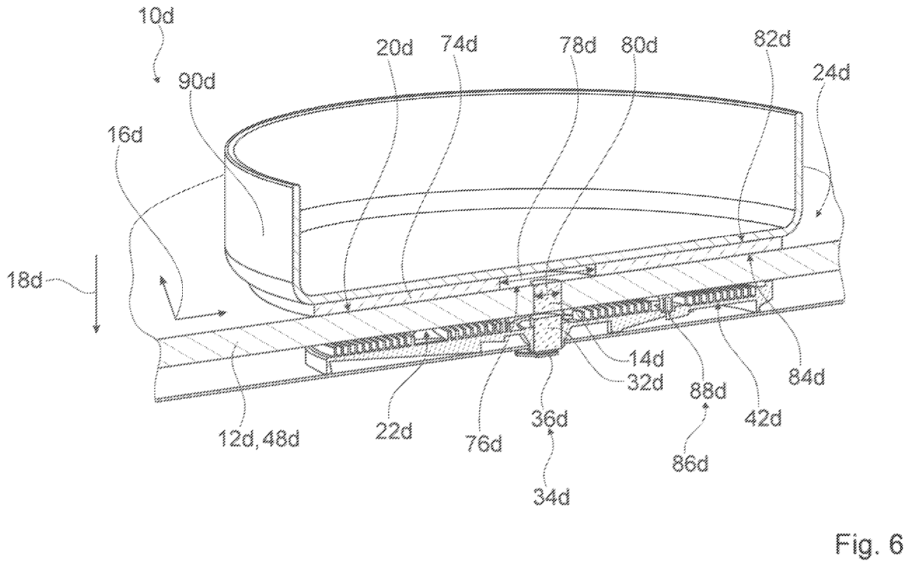

FIG. 6 shows a schematic sectional view of a further exemplary embodiment of a cooking system having a placement plate and a thermal insulation element.

FIG. 1 illustrates a schematic plan view of a cooktop 50a. The cooktop 50a is designed as an induction cooktop. The cooktop 50a has a cooking system 10a.

The cooking system 10a has a placement plate 12a. The placement plate 12a is designed as a cooktop plate 46a.

The cooking system 10a has a heating element 42a. The heating element 42a is designed as an induction heating element. The heating element 42a is provided so as to heat an item of cookware (not shown) that is placed in a heating area 44a on an upper side 20a of the placement plate 12a.

The cooking system 10a has a radiation guiding element 14a. In an assembled state, the radiation guiding element 14a extends at least in part along a normal direction 18a, which is perpendicular to a main extent plane 16a of the placement plate 12a, from the upper side 20a to a lower side 22a of the placement plate 12a (cf. FIG. 2).

The radiation guiding element 14a is made of quartz. The radiation guiding element 14a is permeable for infrared radiation (not shown) and visible light (not shown). When viewed along the normal direction 18a, the radiation guiding element 14a has a substantially smaller surface area extent 28a than the placement plate 12a.

At least one partial area 24a of the placement plate 12a outside the radiation guiding element 14a has a lower transmittance at least for visible light than the radiation guiding element 14a. In the present case, the partial area 24a also extends over the heating area 44a outside of the radiation guiding element 14a. The placement plate 12a has an impermeable coating 58a in the partial area 24a.

FIG. 2 illustrates a schematic sectional view of the cooking system 10a in an assembled state.

In the assembled state, the radiation guiding element 14a is integrated in a cut-out 26a of the placement plate 12a. The cut-out 26a is formed as a bore in the placement plate 12a. In the assembled state, the radiation conducting element 14a is integrated in a positive-locking manner in the cut-out 26a of the placement plate 12a.

The cooking system 10a has a sensor unit 34a, which in the assembled state is arranged offset along the normal direction 18a with respect to the radiation guiding element 14a, so as to detect at least one sensor parameter.

The sensor unit 34a has an infrared temperature sensor 36a. The infrared temperature sensor 36a is designed as a photoelectric sensor, and namely as a photodiode. In an operating state of the cooking system 10a, the infrared temperature sensor 36a detects an intensity of an infrared radiation that is emitted from an item of cookware (not shown) that is placed on the upper side 20a of the placement plate 12a and transported to the infrared temperature sensor 36a by the radiation guiding element 14a, and ascertains therefrom a temperature of the cookware.

The sensor unit 34a has a sensor element 38a. The sensor element 38a is provided so as to assist the infrared temperature sensor 36a and/or so as to detect a further sensor parameter. In the present embodiment, the sensor element 38a is designed as an NTC temperature sensor 52a and is provided so as to measure an ambient temperature of the infrared temperature sensor 36a in order to calculate influences of the ambient temperature on the temperature measurement by means of the infrared temperature sensor 36a.

The cooking system 10a has an illumination unit 40a. In the assembled state, the illumination unit 40a is arranged offset along the normal direction 18a with respect to the radiation guiding element 14a. In an operating state, the illumination unit 40a couples visible light into the radiation guiding element 14a. The illumination unit 40a has a light source 54a. The light source 54a is designed as an RGB LED 56a. In the operating state, the light source 54a provides visible light for coupling into the radiation guiding element 14a. In the operating state, the visible light is transported from the lower side 22a to the upper side 20a of the placement plate 12a by means of the radiation guiding element 14a.

The heating element 42a at least in part surrounds the radiation guiding element 14a when viewed along the normal direction 18a. The heating element 42a has a coil carrier 68a. In a central region 70a of the heating element 42a, the coil carrier 68a forms a base structure 72a. In the assembled state, the sensor unit 34a and the illumination unit 40a are attached to the base structure 72a. In the assembled state, the radiation guiding element 14a extends over the central region 70a of the heating element 42a in the direction of view of the normal direction 18a.

FIG. 3 shows a schematic process flow diagram of a method for operating the cooking system 10a. In the method, visible light is transported from the lower side 22a to the upper side 20a of the placement plate 12a and infrared radiation is transported from the upper side 20a to the lower side 22a of the placement plate 12a. In a first method step 60a of the method, the cooking system 10a is put into operation. In a further method step 62a, visible light that is provided by the light source 54a of the illumination unit 40a is coupled into the radiation guiding element 14a and transported from the lower side 22a to the upper side 20a of the placement plate 12a. In a further method step 64a which may be performed simultaneously with or with a time delay with respect to the further process step 62a, infrared radiation, which is emitted by an item of cookware that is placed on the upper side 20a of the placement plate 12a and is at least in part coupled into the radiation guiding element 14a, is transported from the upper side 20a to the lower side 22a of the placement plate 12a.

FIGS. 4 to 6 illustrate three further exemplary embodiments of the invention. The following descriptions are essentially limited to the differences between the exemplary embodiments, wherein with regard to components, features and functions which remain the same reference can be made to the description of the exemplary embodiment of FIGS. 1 to 3. In order to differentiate between the exemplary embodiments, the letter a in the reference characters of the exemplary embodiment in FIGS. 1 to 3 is replaced by the letters b to d in the reference characters of the exemplary embodiment in FIGS. 4 to 6. With regard to components that have the same designation, in particular with regard to components that have the same reference characters, reference can also be made in principle to the drawings and/or the description of the exemplary embodiment of FIGS. 1 to 3.

FIG. 4 illustrates another embodiment of a cooking system 10b. The cooking system 10b has a placement plate 12b and a radiation guiding element 14b. The radiation guiding element 14b is permeable for infrared radiation and visible light and, in an assembled state, extends at least in part along a normal direction 18b that is perpendicular to a main extent plane 16b of the placement plate 12b from an upper side 20b to a lower side 22b of the placement plate 12b.

At least one partial area 24b of the placement plate 12b outside of the radiation guiding element 14b has a lower transmittance at least for visible light than the radiation guiding element 14b. The placement plate 12b is made of a translucent material having a lower transmittance for visible light than the radiation guiding element 14b.

The cooking system 10b has a further radiation guiding element 32b. The further radiation guiding element 32b is arranged in the assembled state offset along the normal direction 18b with respect to the radiation guiding element 14b. The further radiation guiding element 32b interacts optically with the radiation guiding element 14b. In an operating state of the cooking system 10b, infrared radiation and/or visible light are transmitted between the radiation guiding element 14b and the further radiation guiding element 32b.

The cooking system 10b has a sensor unit 34b that in the assembled state is arranged offset along the normal direction 18b with respect to the radiation guiding element 14b, so as to detect at least one sensor parameter. In the present case, the sensor unit 34b is arranged offset along the normal direction 18b with respect to the radiation conducting element 14b and offset with respect to the further radiation conducting element 32b.

The sensor unit 34b has an infrared temperature sensor 36b and a sensor element 38b. The sensor element 38b is provided so as to assist the infrared temperature sensor 36b and so as to detect a further sensor parameter. The sensor element 38b is designed as an infrared radiation source 66b. In the operating state of the cooking system 10b, the infrared radiation source 66b provides a reference infrared signal (not shown) and couples it into the further radiation guiding element 32b. The reference infrared signal is transmitted from the further radiation guiding element 32b to the radiation guiding element 14b, and is transmitted by the radiation guiding element 14b from the lower side 22b of the placement plate 12b to the upper side 20b of the placement plate 12b. The reference infrared signal is provided for calibration of the infrared temperature sensor 36b. Based on the reference infrared signal, the infrared temperature sensor 36b ascertains an emissivity of an item of cookware (not shown) that is placed on the upper side 20b of the placement plate 12b relative to an ideal heat emitter. The sensor element 38b that is formed by the infrared radiation source 66b is also provided so as to detect a further sensor parameter. The further sensor parameter is a presence or absence of an object (not shown), in particular an item of cookware, which is located on the upper side 20b of the placement plate 12b. In the case where there is no object on the upper side 20b of the placement plate 12b, an emissivity detected by the infrared temperature sensor 36b is nearly zero. If an object is placed on the upper side 20b of the placement plate 12b, the emissivity detected by the infrared temperature sensor 36b increases, with the result that the presence of an item of cookware can be inferred.

FIG. 5 illustrates a further exemplary embodiment of a cooking system 10c. The cooking system 10c has a placement plate 12c. The placement plate 12c is designed as a kitchen worktop 48c.

The cooking system 10c has a radiation guiding element 14c. The radiation guiding element 14c is permeable for infrared radiation and visible light, and in an assembled state extends at least in part along a normal direction 18c that is perpendicular to a main extent plane 16c of the placement plate 12c from the upper side 20c to a lower side 22c of the placement plate 12c.

The cooking system 10c has a heating element 42c. The heating element 42c is designed as an induction heating element and is provided for heating an item of cookware that is placed on the upper side 20c of the placement plate 12c.

At least one partial area 24c of the placement plate 12c outside the radiation guiding element 14c has a lower transmittance at least for visible light than the radiation guiding element 14c. In the present case, the placement plate 12c that is designed as a kitchen worktop 48c is made of a material that is impermeable for visible light.

In the assembled state, the radiation guiding element 14c has a greater extent 30c along the normal direction 18c than the placement plate 12c. In the assembled state, the radiation guiding element 14c extends from the upper side 20c of the placement plate 12c along the normal direction 18c over the lower side 22c of the placement plate 12c. In the assembled state, the radiation guiding element 14c extends along the normal direction 18c into a central region 70c of the heating element 42c.

The cooking system 10c has a sensor unit 34c and an illumination unit 40c, each of which is designed analogously to the exemplary embodiment of the cooking system 10b of FIG. 4. By means of the illumination unit 40c and the radiation guiding element 14c, a suitable positioning of an item of cookware (not shown) on the upper side 20c of the placement plate 12c that is designed as a kitchen worktop 48c can be indicated to a user in an operating state of the cooking system 10c.

FIG. 6 shows another embodiment of a cooking system 10d. The cooking system 10d has a placement plate 12d. The placement plate 12d is designed as a kitchen worktop 48d. The cooking system 10d has a thermal insulation element 74d, which can be arranged on an upper side 20d of the placement plate 12d and is provided so as to protect the placement plate 12d against temperature influences. The thermal insulation element 74d has a cut-out 76d through which the placement plate 12d is visible.

The thermal insulation element 74d has an upper side 82d and a lower side 84d. The upper side 82d of the thermal insulation element 74d is provided so as to support an item of cookware 90d. The lower side 82d is provided for contacting the placement plate 12d, and specifically the upper side 20d of the placement plate 12d. The lower side 84d has a lower degree of roughness than the upper side 82d. This facilitates a sliding of the thermal insulation element 74d together with the cookware 90d on the upper side 20d of the placement plate. In the present case, grooves (not shown) are introduced on the upper side 82d of the thermal insulation element 74d in order to increase a roughness and to counteract a slipping of the cookware 90d relative to the thermal insulation element 74d, whereas the lower side 84d of the thermal insulation element 74d is untreated and already has a smooth surface with a low degree of roughness due to the manufacturing process.

The cooking system 10d has a heating element 42d. The heating element 42d is designed as an induction heating element. The heating element 42d is provided so as to heat the cookware 90d. The cookware 90d is placed on the upper side 82d of the thermal insulation element 74d. In a heating operating state of the heating element 42d, the cookware 90d is inductively heated. The thermal insulation element 74d has a material with a very low thermal conductivity of at most 0.021 W/(m K), with the result that in the heating operating state, a heat transfer of a heat radiated from the cookware 90d to the placement plate 12d is greatly reduced compared to a case in which the cookware 90d is directly placed on the upper side 20d of the placement plate 12d and is heated, and the placement plate 12d is protected against temperature effects.

The cooking system 10d has a radiation guiding element 14d. The radiation guiding element 14d is designed substantially identically to the radiation guiding element 14b of the exemplary embodiment of the cooking system 10b, and therefore reference is made at this point to the above description of FIG. 4 with respect to the radiation guiding element 14d.

The cut-out 76d of the thermal insulation element 74d has a diameter 78d, which corresponds to at least a diameter 80d of the radiation guiding element 14d. In the present case, the diameter 78d of the cut-out 76d of the thermal insulation element 74d is larger than the diameter 80d of the radiation guiding element 14d. Provided that the thermal insulation element 74d is correctly arranged on the upper side 20d of the placement plate, as shown in FIG. 6, the radiation guiding element 14d is not covered by it.

The cooking system 10d has a position sensor unit 86d, which is provided to detect a positioning of the thermal insulation element 74d. The positioning unit 86d comprises a positioning sensor element 88d. The positioning sensor element 88d is arranged below the worktop 12d and is in contact with the lower side 22d of the worktop 12d. The positioning sensor element 88d is designed as an NTC temperature sensor. As soon as the heating element 42d is put into operation and the heating operating state occurs, the positioning sensor element 88d measures a temperature of the placement plate 12d at regular time intervals. In the case where the thermal insulation element 74d is not positioned on the upper side 20d of the placement plate 12d in the heating operating state, the positioning sensor element 88d detects a rapid increase in the temperature of the placement plate 12d. The position sensor unit 86d interprets a rapid rise in the temperature of the placement plate 12d as an absence of the thermal insulation element 74d. The positioning sensor unit 86d is connected to a control unit (not shown). In the case of a rapid rise in the temperature of the placement plate 12d that is measured by the positioning sensor element 88d, the control unit (not shown) could output a warning signal to a user via an output unit (not shown) and/or limit a heating power that is provided by the heating element 42d to the cookware 90d to a level that is not critical for the placement plate 12d. In the event that the thermal insulation element 74d is positioned between the placement plate 12d and the item of cookware 90d in the heating operating state, the temperature of the worktop 12d that is measured by the positioning sensor element 88d increases only very slowly, which is interpreted by the position sensor unit 86d as a presence of the thermal insulation element 74d. The cooking system 10d has a sensor unit 34d that in an assembled state is arranged offset along a normal direction 18d with respect to the radiation guiding element 14d so as to detect at least one sensor parameter. The sensor unit 34d has an infrared temperature sensor 36d and is designed substantially identically to the sensor unit 34a of the cooking system 10a, and therefore reference is made to the above description of FIGS. 1 to 3 for further information regarding the sensor unit 34d.

By an interaction of the position sensor unit 86d with the sensor unit 34d, a detection of the positioning of the thermal insulation element 74d can be improved. In the case of correct positioning of the thermal insulation element 74d as illustrated in FIG. 6, a temperature that is measured by the infrared temperature sensor 36d in the heating operating state of the heating element 42d is substantially higher than a temperature that is measured by the positioning sensor element 88d. In the case of a non-mispositioning of the insulation element 74d, when the cut-out 76d of the thermal insulation element 74d is not positioned above the radiation guiding element 14d with the result that the radiation guiding element is fully or in part covered by the thermal insulation element 74d, a temperature that is measured by the infrared temperature sensor 36d and a temperature that is measured by the positioning sensor element 88d are substantially identical. In the case of improper positioning of the insulation element 74d, the control unit (not shown) could output an indication to a user via the output unit (not shown).

### REFERENCE CHARACTERS

10 Cooking system
12 Placement plate
14 Radiation guiding element
16 Main extent plane
18 Normal direction
20 Upper side
22 Lower side
24 Partial area
26 Cut-out
28 Surface area extent
30 Extent
32 Further radiation guiding element
34 Sensor unit
36 Infrared temperature sensor
38 Sensor element
40 Illumination unit
42 Heating element
44 Heating area
46 Cooktop plate
48 Kitchen worktop
50 Cooktop
52 NTC temperature sensor
54 Light source
56 RGB LED
58 Impermeable coating
60 First method step
62 Further method step
64 Further method step
66 Infrared radiation source
68 Coil carrier
70 Central region
72 Base structure
74 Thermal insulation element
76 Cut-out
78 Diameter
80 Diameter
82 Upper side
84 Lower side
86 Position sensor unit
88 Positioning sensor element
90 Cookware

1-19. (canceled)

20. A cooking system, comprising:
a placement plate; and
a radiation guiding element which is permeable for infrared radiation and visible light, said radiation guiding element extending in an assembled state at least in part along a normal direction perpendicular to a main extent plane of the placement plate from an upper side to a lower side of the placement plate.

21. The cooking system of claim 20, constructed in a form of an induction cooking system.

22. The cooking system of claim 20, wherein at least one partial area of the placement plate outside the radiation guiding element has a lower transmittance at least for visible light than the radiation guiding element.

23. The cooking system of claim 20, wherein the radiation guiding element is integrated in the assembled state in a cut-out of the placement plate.

24. The cooking system of claim 20, wherein the radiation guiding element has a surface area extent which is significantly smaller than a surface area extent of the placement plate when viewed along the normal direction.

25. The cooking system of claim 20, further comprising a further radiation guiding element which is permeable for infrared radiation and visible light and which in the assembled state is arranged offset along the normal direction with respect to the radiation guiding element and interacts optically with the radiation guiding element.

26. The cooking system of claim 20, wherein in the assembled state the radiation guiding element has along the normal direction an extent which is greater than an extent of the placement plate.

27. The cooking system of claim 20, further comprising a sensor unit, which in the assembled state is arranged offset along the normal direction with respect to the radiation conducting element so as to detect a sensor parameter.

28. The cooking system of claim 27, wherein the sensor unit includes an infrared temperature sensor.

29. The cooking system of claim 28, wherein the sensor unit includes a sensor element configured to assist the infrared temperature sensor and/or to detect a further sensor parameter.

30. The cooking system of claim 20, further comprising an illumination unit arranged in the assembled state offset along the normal direction with respect to the radiation guiding element, said illumination unit configured to couple visible light into the radiation guiding element in an operating state.

31. The cooking system of claim 20, further comprising a heating element, which when viewed along the normal direction at least in part surrounds the radiation guiding element.

32. The cooking system of claim 31, wherein the heating element is an induction heating element.

33. The cooking system of claim 20, wherein the placement plate is designed as a cooktop plate or as a kitchen worktop.

34. A cooking system, comprising:
a placement plate; and
a thermal insulation element configured for arrangement on an upper side of the placement plate and to protect the placement plate against temperature influences, said thermal insulation element including a cut-out through which the placement plate is visible.

35. The cooking system of claim 34, wherein the cut-out has a diameter which corresponds at least to a diameter of the radiation guiding element.

36. The cooking system of claim 34, wherein the thermal insulation element has an upper side and a lower side which has a degree of roughness which is lower than a degree of roughness of the upper side, said lower side of the thermal insulation element contacting the placement plate.

37. The cooking system of claim 34, further comprising a position sensor unit configured to detect a positioning of the thermal insulation element.

38. A cooktop, in particular an induction cooktop, said cooktop comprising a cooking system configured in one of two ways, a first way in which the cooking system comprises a placement plate and a radiation guiding element which is permeable for infrared radiation and visible light, said radiation guiding element extending in an assembled state at least in part along a normal direction perpendicular to a main extent plane of the placement plate from an upper side to a lower side of the placement plate, a second way in which the cooking system comprises a placement plate and a thermal insulation element configured for arrangement on an upper side of the placement plate and to protect the placement plate against temperature influences, said thermal insulation element including a cut-out through which the placement plate is visible.

39. A method for operating a cooking system comprising a placement plate, the method comprising:
transporting visible light from a lower side to an upper side of the placement plate; and
transporting infrared radiation from the upper side to the lower side of the placement plate.
